(19) United States
(12) Patent Application Publication
(10) Pub. No.: US 2007/0219978 A1
(43) Pub. Date: Sep. 20, 2007

(54) Method for Processing Questions Sent From a Mobile Telephone

(75) Inventor: Nicholas Simon Myers, London (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: ISSUEBITS LIMITED, London (GB)

(21) Appl. No.: 10/598,995

(22) PCT Filed: Mar. 18, 2005
(86) PCT No.: PCT/GB05/01040

§ 371 Date: Sep. 18, 2006

(30) Foreign Application Priority Data
Mar. 18, 2004 (GB) GB 0406121.4

(51) Int. Cl. G06F 17/30

(52) U.S. Cl. 707/5

(57) ABSTRACT

A user sends a SMS text message with a question; this message is then received at a central computer and sent out to one or more human researchers to compose an answer. An answer is sent back as a text message to the mobile telephone. The question is not restricted to any category of question types and the question is sent using a premium rate text service. Because a premium rate text service is used, this hugely simplifies the practical task of actually deploying a working system since it greatly reduces the complexity of the technical infrastructure that is required. In particular, the customer databases and billing systems can be dispensed with.

### FIELD OF THE INVENTION

This invention relates to a method of simplifying the technical infrastructure deployed in a system for processing questions sent from a mobile telephone. The term ‘mobile telephone’ covers any portable device with voice and data communications capability; it therefore extends to cover smart phones, communicators and voice enabled PDAs. Such devices generally have small keyboards and display screens, making conventional web-based searching to obtain answers to ‘general information questions’ both slow and awkward.

### DESCRIPTION OF THE PRIOR ART

The state of the art in information retrieval by conventional internet search engines (e.g. Google™) is to select documents that are in some way related to a user's query and then to rank them in terms of their closeness to matching the original query. A ranked list of documents is retrieved by the search engine and summaries are sent for display on an end-user's browser. It is then up to the user to either select the correct document or to browse the set of ranked documents. Given the huge number of documents available on the Internet, the result is often thousands of documents, many of marginal relevance. This can be a frustrating experience for the user, especially for users who are untrained in how to create effective queries or in interpreting the results.

The vastly increasing amounts of digital information being made available on the Internet will further exacerbate the poor performance of the current systems. While it is to be expected that these systems will improve their algorithms over time, it is likely that the user will still have difficulties as the documents being searched were never explicitly written to answer all the arbitrary queries that can be raised by users.

Capturing the meaning of a natural language query, using that to locate an answer by searching across extensive numbers of documents and then automatically constructing a natural language answer to that query has long been a goal of artificial intelligence and remains the core direction of research in this area. Because reaching this goal is a distant prospect, specialised services are known which allow end-users to send by e-mail or web browser questions for human researchers to answer. These human based systems are especially useful for answering ‘general information questions’; these are questions that are not domain specific, such as questions as to current sports scores, stock prices, weather etc. or other very limited kinds of data. For a completely unconstrained domain of questions, the human researcher, using internet based search engines, is still a reasonably effective, although potentially inefficient, solution. Reference may for example be made to the service ‘MojoKnows’, which allows a user to send any question via a SMS text message from a mobile phone which will then be researched and answered by people conducting internet based searches and replying with a SMS text message.

SMS text messaging is the most successful mobile telephony data service. The GSM association forecast that 200 billion text messages would be sent over the worldwide GSM networks during 2001 and 360 billion during 2002. In January 2004 the Mobile Data Association (MDA) estimated that 20.5 billion text messages were sent in the UI during 2003, with a daily average in December of 61 million text messages. The MDA forecast that text messaging will reach 23 billion in 2004. A premium rate service (either text or voice) is a development of text messaging, launched initially during 1998 in some Scandinavian countries and followed shortly in the UK. Premium rate services offer a revenue-sharing model similar to existing premium rate voice (IVR) services. The core principles are that the mobile phone user pays a premium tariff to access value added services or content. The premium rate can be applied either to a user requesting the premium service, mobile originate (MO), or receiving the premium service, mobile terminate (MT).

### SUMMARY OF THE INVENTION

The present invention is a method of simplifying the technical infrastructure deployed in a system for processing questions sent from a mobile telephone over a wireless bearer. In first aspect, it comprises the following steps:
(a) receiving a question sent from the mobile telephone;
(b) handling that question by sending it out for review by one or more human researchers to compose an answer;
(c) sending the answer in plain text to the mobile telephone;
   wherein the question is not restricted to any category of question types, is expressed in natural language and is sent using a premium rate text service.

The answer is preferably a succinct (less than 160 characters) text message. The present invention is implemented as a system called AQA™ (“Any Question Answered”). AQA is a premium rate text service running on mobile phone networks aimed at the consumer market. Because it uses premium rate text messaging, the conventional technical infrastructure deployed in question answering systems can be considerably simplified. In particular, it eliminates the need for a customer database that would list all entities eligible to use the system; secondly, it eliminates the need for costly billing systems.

More specifically, conventional question answering systems, such as that disclosed in EP 1343102 Fujitsu, require a customer database that lists all those entities entitled to use the system. These systems are hence used for in-house deployments and frequently also for subscriber based question answering systems (e.g. 90 day free software support for consumer software; other kinds of subscriber based services). The strong assumption in designing question answering systems has been that it is necessary to deploy a customer database that lists all those entitled to use the service (e.g. employees; subscribers etc.). The present invention is based on the insight that this assumption is in fact flawed and leads to a technical infrastructure more complicated than it needs to be. A counter-intuitive consequence of simplifying the technical infrastructure of removing the customer database is that it becomes possible to have a system which can be used by anyone with access to a mobile telephone—a vast expansion in the potential user base.

First, the prior art reliance on a customer database means that this database has to be constructed, hosted, maintained and also interrogated whenever a question is received. Interrogation can be slow: for example, when you first telephone a software helpdesk under a typical 90 day warranty cover, you first have to give your unique ID printed on the original packaging, which then has to be matched up to the customer database which logs the details of all purchasers who have returned their registration/warranty cover cards in the post or on-line. This significantly increases the time on the call (and hence its cost) and can be frustrating if the registration/warranty card has not yet been processed.

The present invention entirely eliminates entirely the need for a customer database, leading to a far simpler technical infrastructure. In particular, by requiring all questions to be sent using a premium rate text service, it allows any person who can access the premium rate service to send in a question: there is no requirement to be present in any kind of customer database. Because there is no intermediary step of querying a customer database to ascertain if the query comes form a valid user, the questioner never has to spend time on-line with the helpdesk whilst their presence in a customer database is verified and hence processing times are reduced.

Further, commercial helpdesk systems (i.e. those available on a subscription basis, as opposed to in-house deployments available free to all employees) must integrate the customer database with a billing system: these are complex and sophisticated and will handle numerous functions, such as sending invoices, payment reminders and statements; tracking customer payments, and notifying the customer database of new and expired customers. Billing systems for mobile telephone customers with no direct debit payment or credit card payment (i.e. for pay-as-you-go mobile telephones) are especially complex because of the different kinds of credit top-up processes available. The present invention entirely eliminates the need for this kind of billing infrastructure because it requires that the question be sent using a premium rate text message: it is the mobile telephone network operator that tracks useage of all premium rate services used by its customers, adds these to its bills to its customers and makes a payment of a proportion of revenues to the question answering service (e.g. a bulk payment per quarter). Hence, it leverages off the considerable investment in an already existing billing infrastructure.

Conventional subscriber based helpdesk systems would need to integrate the complex customer database with the complex billing infrastructure and also with the helpdesk system itself used by researchers to track incoming questions and their answers. In practice, this can be a very substantial software integration project. Yet it is avoided entirely by the approach of the present invention.

Finally, it should also be noted that premium rate text services have previously been used to request mobile telephone ringtones and logos and enter competitions. Invariably, the end-user either enters no text at all (i.e. the number called determines the service provided) or enters a simple number or word code to control the kind of service provided. For example, a poster may advertise different ringtones, listing each ringtone against a number. The user sends a SMS text to a premium rate number with the number of the song he wishes to download. Hence, the user does not express his input in a natural language manner at all. Premium rate text messaging has therefore been restricted to systems that handle incoming data requests from mobile telephones in an entirely automated manner. To date, the application of premium rate messaging to systems where human operators will analyse and respond to text messages has not been appreciated. In fact, the whole success of SMS messaging as a medium for natural language communication between humans has been predicated on the extreme low cost of a SMS message. Hence, the idea of using premium rate text messaging for SMS based natural language communication between humans is directly contrary to the fundamental and deeply established character of SMS messaging.

### BRIEF DESCRIPTION OF THE DRAWINGS

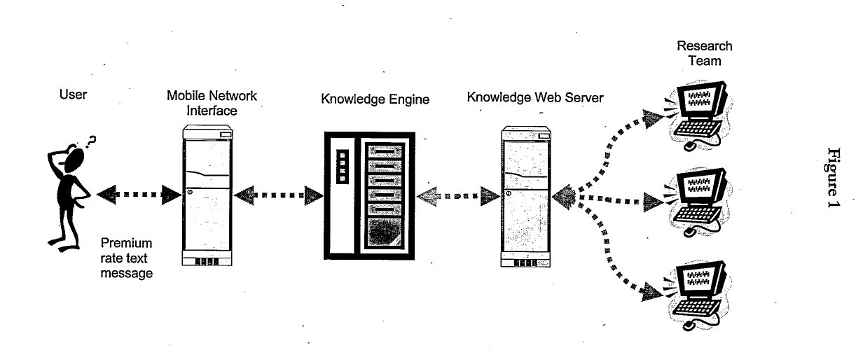

The invention will be described with reference to the AQA implementation, schematically illustrated in FIG. 1.

### DETAILED DESCRIPTION

Overview

In an implementation, consumers will be able to send in any question to the AQA service, via a premium rate text message on their mobile phone. Within minutes, AQA will send a text response to the consumer. Given that it is a text service, all responses will (with current SMS constraints) be no more than 160 characters in length. There is, currently in the UK, a simple £1 charge for consumers, plus their network charges associated with sending their text message (which may vary from network to network), for this service. AQA is able to provide these responses though a combination of an intelligent knowledge engine and a select team of paid researchers. The service will give an answer for any question presented in any way to the service. A mobile phone user can either submit a question via a £1 premium text message or by a £1.50 premium voice call. In either case the answer is sent back to the questioner via a free text message.

AQA handles questions at a first computer that (i) searches a database of previously generated answers for answers that match the question; (ii) automatically generates a list of potential answers to the question from the database; and (iii) automatically sends the unanswered question, together with the list of possible answers, out for review by one or more human researchers, connected to on-line information resources, who then either select one of the answers in the list, or use this list of possible answers together with information from the on-line information sources to compose an answer. Hence, it combines the strength of current generation AI systems with the undisputed strengths of the human being to understand a question and to search, find and express an answer in cogent and concise terms. By supplying the human researchers with potential answers, this avoids many of the difficult problems of trying to implement real search intelligence in software. Further, if the researcher can pick an answer from the list then the response time in providing that answer will be far quicker than if the researcher has to research the answer directly and from scratch.

The system to answer questions is based on a hybrid system of (a) computer software (‘The Knowledge Engine’) that deploys database and information retrieval algorithms, along with (b) human researchers using a web based software system (The Knowledge Entry System). The (Knowledge Engine is the “first computer” defined in the preceding paragraph above. It can be a single computer, or a network of computers or any other distribution of computing resources. The Knowledge Entry system is a web based interface that displays to remote researchers the question and a list of possible answers selected by the Knowledge Engine, plus a countdown timer, and an indicator of the number of outstanding questions.

The key success factors for the service are good quality of answers within a few minutes. The Knowledge Engine ensures these success factors in a number of ways:

1. It will answer certain fact based questions directly, such as share prices and weather reports.

2. It will supply a researcher with the question plus a number of potential answers from the database of previously given answers.

3. It will allow the researcher to search the company's answer database to research previous answers.

4. It will rank answers in the list of potential answers in various useful ways, such as date order, closeness of match etc.

The company will implement two tiers of human researchers. The first tier will handle the frontline of questions and will pass on any questions that are hard to research. These hard questions will be researched by a group of senior researchers. An Editor will be placed in charge of the senior researchers to ensure that the company's editorial policy in answering questions is adhered to by all researchers. The Editor and senior researchers will all be high calibre individuals and will be key employees of the company.

The business will be able to take advantage of the key trends in the industry by delivering a service to answer questions from mobile users using:

(a) Modern information retrieval technology to populate a knowledge database and automatically select appropriate answers from the database to be reviewed by human researchers.

(b) Web based technologies to manage teams of researchers to select, generate and supply answers to questions over the internet.

(c) Improving hardware and software technologies to enhance information retrieval systems performance so that 80% or more of questions can be answered from an automatically generated list provided to researchers.

(d) Mobile telephony to provide the AQA service to customers via premium voice and premium text messaging.

What is the AQA Service?

The AQA service is a premium rate mobile phone service. It enables users to ask any question on their mobile phone and for the system to send a text answer within minutes of receiving the question. The primary method of asking questions is via a premium text number. Initially the service will be launched in the UK where the service number is 63336 for text questions. This number will work across all UK mobile networks and will cost the users £1 plus the network charge per question. Users will not be charged for the text message response.

Critically, the billing system is set up within the mobile network operators. It is usually a mobile originating ‘MO’ premium text service. The customer is billed as soon as they send a question. Alternatively, it could be a mobile terminating ‘MT’ premium text service (also known as reverse billing), where the subscriber is billed when he is sent a reply. Out of this the company receives a revenue share from the network operators. This approach hugely simplifies the practical task of actually deploying a working system since it greatly reduces the complexity of the technical infrastructure that needs to be designed and deployed.

Users can ask the question in any way including commonly used text-shorthand (like “gr8” for great), misspelled words, incomplete questions, abbreviations etc. In addition an “AQA Command Language” can be used such as “.w london” for weather in London or “.s psion” for latest share price for Psion Plc.

The answer provided is a full description, including:

(i) A restatement of the question asked.

(ii) An answer to the question including details to make the answer specific (e.g. a date or time).

(iii) If possible, extra information around the subject (the ‘wow’ factor).

A secondary method of asking questions will be via a premium voice service. This will be set up to run alongside the primary service and will be priced at a higher level to cover the cost of having to translate the voice message into a text message before it can be answered.

How the AQA Service Works

The AQA service uses an intelligent Knowledge Engine together with people (researchers) to provide a system that can answer any question within a few minutes. It works as follows:

(1) Only mobile phone users can use the AQA service.

(2) Users have the option of sending a question to the premium text service or by calling the premium voice service and having their question recorded.

(3) If a question is submitted by text message it reaches the Knowledge Engine via the Mobile Network Interface and is then either answered automatically by the Engine (if possible) or forwarded to human researchers.

(4) If a question is submitted by a voice call it is first translated into text by a human researcher before submitting to the Knowledge Engine. It is then answered automatically by the Engine (if possible) or returned to the researcher.

(5) Researchers are remote based individuals, working from their own premises, accessing the system over the internet using the Knowledge Entry System.

(6) The Knowledge Entry system is a web based interface that displays a question and a list of possible answers selected by the Knowledge Engine by applying search and relevance ranking algorithms to match the question to previously answered questions and answers. The Knowledge Entry system also displays a countdown timer, and an indicator of the number of outstanding questions.

(7) Researchers answer questions that the Knowledge Engine cannot answer automatically—the Engine will suggest possible answers from a database of previously generated answers that can be chosen, or the researcher must find an answer themselves (usually by searching the internet).

(8) Researchers provide ‘human’ understanding, so any question worded in any way can be understood.

(9) The researcher summarises the answer succinctly, so that a good quality answer is fitted into a maximum of 160 characters (when SMS text messaging is used; for MMS, there is no such restriction).

(10) Each answer is sent as a text message (which term includes related formats such as EMS and MMS format) back to the user and also stored in the Knowledge Engine for future questions, so that knowledge builds up over time.

(11) Researchers are paid per question answered.

(12) The service runs 24 hours a day, 7 days a week.

(13) Answers are usually sent back to the user within a few minutes. If the rate of questions rises above the rate of answering, the answer may be delayed. If the delay is greater than 15 mins, a text message is automatically sent to the user informing them of the delay and forecasting the time when their question will be answered.

To provide a fast response time to the majority of questions, a two tier system is used with Frontline Researchers attempting to answer all questions initially and passing hard questions to Senior Researchers.

The Main Principles are:

(1) Frontline Researchers have a maximum 10 mins to answer each question. Also they can reject the question earlier if they know they cannot answer it. If they fail to answer it, it goes to another Frontline Researcher. After three attempts by a Frontline Researcher, the question goes on a “Hard Question” list which Senior Researchers work from. Senior Researchers have up to 1 hour to answer the question (they must provide an answer of some sort in that time).

(2) The Editor interprets an editorial policy and is responsible for the whole researcher system working effectively, ensuring good quality and consistent answers.

(3) Frontline and Senior Researchers work shifts and flexible hours. Frontline Researchers can be part-time. When there is a high rate of questions, researchers are automatically sent a text message to their own mobile phone to request they come online and get to work answering questions.

(4) If there are no “Hard Questions” the Editor and Senior Researchers can answer questions from normal question list in the same way as Frontline Researchers.

(5) All researchers have access to an Instant Messaging system that allows them to chat to each other over the internet if they need help answering a question.

Quality Control

The key factors to making AQA an excellent service are:

A The Quality of the Answers.

The success factors to providing quality answers are:

1. Re-use: i.e. answers which have already been given are stored in the database of answers and can be used again.

2. Researchers provide accurate and succinct answers to questions that have not been answered previously, which in turn depends on recruiting good researchers and then training the researchers to perform well.

3. Senior researchers reviewing a sample (10%) of all answers given by frontline researchers.

3. Access to reliable sources of information.

B The Timeliness in Delivery of the Answers.

The success factors in providing timely answers are:

1. Re-use: i.e. answers which have already been given once can be used again.

2. Some very specific classes of questions can be answered directly by the Knowledge Engine without researcher intervention such as share price, weather and news queries. In either case a target is that 80% of questions are answered by either (1) or (2) above.

Quality and timeliness is monitored by the Knowledge Engine checking answers for spelling, level of content, etc and providing statistics on researcher performance (rate of answering, number of questions skipped, etc).

System Enhancements

Researchers will be provided by the Knowledge Entry System with a list of recent (or all) previous questions and associated answers sent from a given user when answering a new question from that user. This may enable the researcher to understand better the context in which the question is being asked (which may be a follow-on question from an earlier question, which would be meaningless without a knowledge of that earlier question and the associated answer).

Researchers will also be provided by the Knowledge Entry System with an indication of the current location of the user (e.g. by using conventional automatic location finding services that are deployed in wireless communications systems). This allows the researcher to answer a question like “where is the closest petrol station?”

The question can include a picture and optionally some text or voice which the researcher then scans and determines. For example a customer could take a picture of a bottle of wine and ask where can I buy this wine, or send us a picture of a celebrity and ask “Who is this person?” The Knowledge Engine passes the image to researchers using the Knowledge Entry System, who then view/understand the image, and generate an answer. This may involve matching the image directly or translating it—i.e. describing it in words and then undertaking a search using those words.

Questions can be sent to the Knowledge Engine using packet switched data using GRPS, CDMA, WCDMA data connections (which terms also include their derivatives).

APPENDIX 1
Example Questions and Example Answers

| Category | Example question | Model answer |
|---|---|---|
| Historical Factual/ | is the earth round | The Earth's shape is an oblate spheroid with |
| Science/History/ | | average radius of 6357 km from pole to pole and |
| Geography/Languages/ | | 6378 km parallel to the equator |
| General Knowledge/ | is hyde-park bigger | Central park is bigger being 843 acres compared |
| Directory Enquiries | than central park | to 350 acres for Hyde park |
| Answer not likely to | What is the origin of | The Big Bang theory suggests the universe |
| change over time. | the universe | began from a massive expansion 13 billion years |
| | | ago. Georges Lemaître suggested this theory in |
| | | the 1930s. |
| | Is a cucumber fruit or | A cucumber surprisingly is a fruit. A fruit is |
| | veg | defined as the mature ovary of a plant - ie that it |
| | | has seeds. |
| | when is my cat poppy | Cats have a gestation period of 61 to 69 days. |
| | going to give birth | Before birth the mammary glands will swell |
| | | noticeably and the cats body temperature will |
| | | rise.′ |
| | What are the big 5 | The big five animals are the Lion, Leopard, |
| | animals | Elephant, Buffalo and Rhino. It was called the |
| | | big five because shooting all five was a |
| | | challenge. |
| | can a bullet escape | No, a bullet cannot escape the Moon's gravity. |
| | gravity of the moon. | The Moon's escape velocity is 2.38 km/s but the |
| | | fastest bullets only travel at about 1.2 km/s. |
| | how do I make a | Sorry, but the AQA policy is not to respond to |
| | bomb | questions of this type. |
| | How many bones in | At birth there are some 275 different bones. As |
| | the body? | the body matures some bones, such as wrist and |
| | | ankle bones, fuse together leaving 206 bones in |
| | | an adult. |
| | what famous people | Christy Turlington (35), Cuba Gooding Jr. (36), |
| | were born on 2 january | Tia Carrere (37), Roger Miller (68), Isaac |
| | | Assimov (84) and Sally Rand were all born on 2 |
| | | Jan. |
| News/Sport/Weather/ | score chelsea | Score at 3.17 pm is Chelsea 2 Arsenal 1, Zola |
| Entertainment/TV/ | | scored after 3 mins, Flo, 24 mins, Bergkamp, |
| Soaps/Celebrity/ | | 44 mins |
| Films/Politics/ | Ch sc | Chelsea won 4-0 away against Leicester City on |
| Travel/Flights/ | | 11 Jan. 2004. The match attendance was 31,547. |
| Restaurant Guides/ | | Chelsea are currently 3rd in the premiership on |
| City guides/ | | 16 Jan. 2004. |
| Gambling/Hotels/ | who won the rugby | England won the Rugby World cup 2003 on Sat |
| Traffic/Directions | | 20^{th} Oct, beating Australia 20-17 after a drop |
| Answer is likely to | | goal from flyhalf Jonny Wilkinson in last |
| change. | | minute of extra time |
| | What sign is David | Taurus is David Beckham's zodiac star sign. He |
| | Beckham | was born on 2 May 1975 (a Friday). |
| | Is flight ba223 on | BA223 is 18 minutes ahead of schedule arriving |
| | schdule | at 4.02 pm on 16 Jan. 2004. Its scheduled arrival |
| | | time was 4.20 pm.′ |
| | Where is home and | Jackaroo Ranch at Annangrove, north west of |
| | away filmed | Sydney, Australia is where many of Home and |
| | | Aways scenes have been filmed for the past 15 |
| | | years.′ |
| | What is the best bet in | The bet in craps, a game played with two six |
| | craps? | sided dice, that has the best odds is the “behind |
| | | the line” bet when a 4, 5, 6, 8, 9 or 10 has been |
| | | thrown. |
| | Suggest a cheap | Thai Bistro is a pleasant, if plain, budget |
| | restaurant in w4 | restaurant to visit serving good food. You can |
| | | find it at 99 Chiswick High Road, W4 2ED Tel: |
| | | 020 8995 5774. |
| | How do I get my tv | You can get a TV repaired at BSI Electronic |
| | fixed near chiswick | Products at address Unit 389, Chiswick High |
| | | Road, London W4. |
| | Whats the name of the | Stella Street is the name of the comedy with |
| | impersonation comedy | impersonations. Phil Cornwelle created and |
| | called street something | starred in it. |
| Shopping/ | which should I buy | The Sony Ericsson P900 smartphone is more |
| Products/Services/ | Nokia 6600 or SE | PDA centric while the Nokia 6600 smartphone |
| Books/CDs/Cars/ | P900 | is more voice centric. Both phone run the |
| Houses/ | | Symbian v7 OS. |
| | Whats the best mobile | On 16 Jan. 2004 the top pay as you go mobile |
| | phone deal for an | phones at CPW are Motorola T192(£34.99), |
| | infrequent user | Siemens A55(£39.99), Nokia 3310(£49.99), |
| | | Nokia 3510i(£79.99) |
| | Give me some cheat | Empire Earth cheat codes are: “asus drivers” |
| | codes for Empire | reveals map, “boston food sucks” 1000 food, |
| | Earth | “atm” 1000 gold, “you said wood” 1000 wood, |
| | | “creatine” 1000 iron |
| | What fiction book | According to Amazon people who bought Iain |
| | should I read. I like ian | Banks books also enjoyed Not the End of the |
| | banks but want other | World by Kate Atkinson. Reviewed as funny |
| | author. | and sharp. |
| Business/Financial | psion sh price | Psion share price was 96.5p at 5.00 pm 16 Jan. |
| | | 2004 with 774,000 shares traded. |
| | Is the stock market | It is not possible to predict when stock markets |
| | going to crash soon | are going to crash. The FTSE has risen from |
| | | 3,567.4 in January 2003 to 4,456.1 in January 2004. |
| | Who is the richest | In 2003 the richest person in the UK was |
| | person in uk | estimated to be the Duke of Westminster, who |
| | | has a fortune of £4.9bn. Britain has 21 |
| | | billionaires. |
| | How many txt | 35 text messages are sent per day per user on |
| | messages are sent per | average in the UK (reported in Jan 2004). |
| | day per user in uk | |
| Personal/Health | Should i kill myself | You should seek help from the Samaritans - |
| | | phone 08457 90 90 90 or see |
| | | www.samaritans.org |
| | how do I get a gf | A good way to find a girlfriend is to use internet |
| | | dating sites such as: match.com, udate.co.uk, |
| | | topdating.com, speeddater.co.uk |
| | How many headache | You must always follow the instructions |
| | pills can I take | provided with headache pills and never exceed |
| | | the recommended dose. If in doubt consult |
| | | your doctor. |
| Fun/crosswords/ | What will lottery | The odds of winning any prize are 1 in 54. |
| Puzzles/gimmicks/ | numbers be | Jackpot is 1 in 13,983,816. Suggestion: 7, 25, 26, |
| jokes horoscopes | | 27, 48, 49 |
| | is there a god | People draw their own conclusions as to the |
| | | existence of a god. Many religions believe in |
| | | the existence of a god or gods. |
| | What question cannot | All questions can be answered by AQA by |
| | be answered | texting 63336 |
| | What is the 3^{rd} word | “The” is the most frequently used word in the |
| | on page 86 of the | English language. So without knowing the book |
| | book under my bed | the most likely word is “the”. |
| | What is 7 across in | In the Times Crossword for today (16 Jan. |
| | times xword | 2004), there is no 7 across. Yesterday (15 Jan. |
| | | 2004), 7 across was “Roadworks” |
| | Horoscope for | January 2004 Capricorn horoscope: In work, a |
| | Capricorn | promotion or an improvement is possible. |
| | | Good surprises are due and you will feel full of |
| | | energy. |

1. A method of simplifying the technical infrastructure deployed in a system for processing questions sent from a mobile telephone over a wireless bearer, comprising the following steps:
(a) receiving a question sent from the mobile telephone;
(b) handling that question by sending it out for review by one or more human researchers to compose an answer;
(c) sending the answer in plain text to the mobile telephone;
wherein the question is not restricted to any category of question types, is expressed in natural language and is sent using a premium rate text service.

2. The method of claim 1 in which the step of handling includes the step of handling the question at a first computer that (i) searches a database of previously generated answers for answers that match the question; (ii) automatically generates a list of potential answers to the question from the database; and (iii) automatically sends the unanswered question, together with the list of possible answers, out for review by at least one of the human researchers, who then selects one of the answers in the list or uses the list of possible answers together with information from the on-line information resources to compose an answer.

3. The method of claim 2 in which the researcher investigates and writes an answer using the on-line information resources if none of the answers in the automatically generated list of possible answers is suitable.

4. The method of claim 2 in which the first computer automatically determines the correct answer and automatically sends the answer as a message to the mobile telephone.

5. The method of claim 2 in which the question is sent from a mobile telephone by the user calling a premium voice service and having the question recorded and then sent to the first computer.

6. The method of claim 5 in which the question is first translated into text by the researcher before being submitted to the first computer for processing.

7. The method of claim 1 in which the question includes an image and the image is then understood, matched, and translated.

8. The method of claim 2 in which a web based interface is used by the or each researcher and that interface displays the question and the list of possible answers selected by the first computer.

9. The method of claim 8 in which the web based interface also displays a countdown timer.

10. The method of claim 1 in which the researcher summarises the answer succinctly to fit into a maximum of 160 characters.

11. The method of claim 2 in which each answer is stored in the database of previously generated answers at the first computer.

12. The method of claim 1 in which a two tier system of researchers is used, with frontline researchers attempting to answer all questions initially and passing hard questions to senior researchers.

13. The method of claim 12 in which frontline researchers have a maximum predefined time to answer each question and can reject the question earlier if they know they cannot answer it.

14. The method of claim 13 in which, if a frontline researcher fails to answer the question, it goes to another frontline researcher and, after a predefined number of unsuccessful attempts by frontline researchers to answer the question, the question goes on a “Hard Question” list which senior researchers work from.

15. The method of claim 1 in which all researchers have access to an Instant Messaging system that allows them to chat to each other over the internet if they need help answering a question.

16. The method of claim 2 in which the first computer deploys algorithms for one or more of: spell checking of answers; content level checking of answers.

17. The method of claim 2 in which the first computer monitors the performance of the answer generating method and provides statistics on one or more of: question rate, rate of answering, time taken to answer by each researcher, hours logged by each researcher.

18. The method of claim 1 in which the researcher is automatically provided with a list of recent (or all) previous questions and associated answers sent from a given user when answering a new question from that user.

19. The method of claim 1 in which the researcher is automatically provided with an indication of the current location of the user.

20. The method of claim 1 in which the question and answer are sent using SMS.

21. The method of claim 1 in which the question and answer are sent using EMS or MMS.

22. The method of claim 1 in which the question and answer are sent using GPRS, CDMA, or W-CDMA data connections.

23. The method of claim 1 in which the premium rate service is either mobile originating (MO) or mobile terminating (MT).

24. The method of claim 1 in which a different question is sent as a premium rate voice message.

24. An answer message sent as the final step in the method of processing questions as defined in claim 1.

25. A mobile telephone when displaying an answer message as defined in claim 24.
